(19) United States
(12) Patent Application Publication
(10) Pub. No.: US 2006/0029824 A1
(43) Pub. Date: Feb. 9, 2006

(54) Heat-sealable polymeric films

(76) Inventors: Bruno R.L. Gringoire, Ville-Houdlemont (FR); Syd R. Wright, Pittsford, NY (US)

Correspondence Address: ExxonMobil Chemical Company;Law Technology, P.O. Box 2149, Baytown, TX, 77522-2149, US

(21) Appl. No.: 10/911,449

(22) Filed: Aug. 4, 2004

(51) Int. Cl. B32B 27/08; B32B 27/32; B32B 7/12; B32B 27/36; B32B 27/30

(52) U.S. Cl. 428/522; 428/35.7; 428/523; 428/349; 428/500; 428/475.8; 428/483; 428/910

(57) ABSTRACT

Heat sealable polymeric films are found to have low minimum seal temperatures and beneficial hot tack performance. The polymeric films incorporate at least one heat sealable coating on at least one surface. The coating incorporates an ethylene copolymer and an acid modified tackifier resin. The coating also provides positive blocking resistance to other coatings and inks, particularly to acrylic inks.

### FIELD OF THE INVENTION

This disclosure relates to heat-sealable polymeric films.

### BACKGROUND OF THE DISLCOSURE

An important consideration in designing certain packaging films is to ensure they can be processed on high speed form/fill/seal machinery. Form/fill/seal packaging systems operate by unwinding continuous film from bulk film rolls, followed by forming pouches, filling the pouches, and, finally, sealing the pouch closed. Thus, the film must have sufficient flexibility to undergo machine folding from a flat orientation to a folded condition, and be subjected to a sealing function, which is part of high-speed packaging apparatus. In selecting the optimum packaging film for its barrier properties, high-speed unrolling and folding are the primary concern. An additional and very important aspect of the packaging process, however, is the ability to effectively seal the pouch after it is filled with the product.

High-speed horizontal and vertical form/fill/seal systems include sealing functions at various stages of the packaging process. In a horizontal form/fill/seal apparatus, individual pouches are formed by folding the multi-layer film in half followed by providing vertical seals along the length of the folded web and separating the pouches along the seals formed by vertical sealing. Optionally, the bottoms of the pouches can also be sealed. After the pouch is formed and filled, the top of the pouch is sealed. Similarly, in vertical form/fill/seal apparatus, the continuous web is formed around a tube and the web is immediately joined together by a longitudinal sealing jaw as either a lap seal or a fin seal. For additional information regarding such packaging systems, see U.S. Pat. Nos. 4,671,047; 4,807,420; 4,090,344; and 4,937,112.

A second sealing function is present in a vertical form/fill/seal configuration which consists of a combination top and bottom sealing section (with a bag cut-off device in between). The top-sealing portion seals the bottom of an empty bag suspended from the bag forming tube while the bottom portion seals the top of a filled bag.

In most processes for packaging products, the package is formed and filled by creating a heat seal between two opposed layers of film to form a pocket and almost simultaneously sliding or dropping the product into the pocket. In these form and fill packaging techniques a continuous flat web of packaging film is fed around a form which shapes it into a tube, the tube is slipped over a hollow form and the free edges of the tube are sealed together. The tube so formed is then passed between a pair of hot sealing jaws which create a series of discrete packages by collapsing the film onto itself and forming a seal by the application of heat and pressure. The product is introduced into each package through the hollow form in the interval between the heat seals. During high operating speeds, the product is dropped into the package while the sealing jaws, which form the seal, are closed. With both vertical and horizontal form and fill sealing applications the heat seal should be strong enough to support and retain the product after the sealing jaws open to release the film. It is often desirable to release the sealing jaws soon after the seal is formed so a film which accomplishes this by exhibiting a high “hot tack” is very useful. Hot tack refers to the strength of the heat seal immediately following the sealing operation.

Additionally, in packaging applications there is a great demand for heat sealable films which can be subjected to temperatures high enough to seal the films without causing the substrate to cockle or pucker. One approach for achieving this is by coating a film substrate with a layer of heat sealable material which adheres strongly to the substrate and which can be melted at a temperature below the softening temperature of the substrate. Heat-sealable coatings with low melting temperatures are often preferred because the substrate is less likely to be damaged during heat sealing.

U.S. Pat. No. 5,419,960 discloses a film with a low temperature sealable coating. The coating contains a copolymer of ethylene and acrylic or methacrylic acid. U.S. Pat. Nos. 6,077,602 and 5,843,582 disclose heat sealable film coatings containing a terpolymer produced from a nitrile monomer, an acrylate or 1,3 butadiene monomer, and an unsaturated carboxylic acid or sulfoethyl methacrylate. U.S. Pat. Nos. 6,013,353 and 5,827,615 disclose metallized films with heat sealable coatings, on the surface of the metal, containing a copolymer of a carboxylic acid and an acrylate, or acrylonitrile or mixtures thereof.

In the preparation of films useful for packaging purposes, the outside of the film or the side of the film which comes in direct contact with the hot sealer surfaces should have good hot slip and jaw release characteristics. Additionally, the film should have good machinability so that the wrapped product can be conveyed easily through the overwrapping machine without sticking to adjacent packages or the parts of the machine with which it comes into contact, which can cause production delays. The film should also have barrier properties.

Acrylic-containing coatings which offer these properties are known. The acrylic-containing coating is applied to one side of the film substrate and another heat sealable coating, such as polyvinylidene chloride (PVdC), or another acrylic coating, is coated on the other side. Acrylic-containing coating formulations provide the film with a good coefficient of friction, which contributes to good machinability characteristics. These acrylic-based coatings also provide films with good barrier characteristics, which improve flavor and aroma protection. Such coatings are described in U.S. Pat. Nos. 4,058,649 and 4,058,645. The PVDC coating or other type of acrylic coating is usually on the inside of the film and provides high seal strength, good hot tack characteristics and barrier properties. These heat sealable coatings have glass transition (“Tg”) temperatures which are higher than room temperature. Such a coated film is disclosed in U.S. Pat. No. 4,403,464.

U.S. Pat. No. 4,456,741 discloses heat sealable terpolymer compositions useful as pressure-sensitive adhesives for use with a backing material such as paper, polyester film or, foamed polymers. The terpolymer heat sealable pressure-sensitive adhesive composition comprises butyl acrylate, N-vinyl-2-pyrrolidinone and styrene. Other heat sealable coatings are disclosed in U.S. Pat. No. 3,696,082 and East German Patent DD-146,604.

U.S. Pat. No. 6,319,979 discloses the use of hot melt adhesives for use in sealing cartons or for bonding layers of cardboard or paperboard together. The adhesives contain ethylene-based polymers and tackifying resins.

Cold sealable pressure-sensitive adhesives have been developed. These adhesives do not require the use of a heated element to seal the packages. However, these adhesives have high surface tack characteristics making them adhere to uncoated surfaces of the packaging film which makes them difficult to use because of film blocking (i.e., sticking).

### BRIEF DESCRIPTION OF THE DISCLOSURE

This disclosure relates to polymeric films incorporating at least one heat-sealable coating on at least one surface. The coating incorporates an ethylene and acrylic acid copolymer and an acid modified tackifier resin. The films may be single or multi-layered films and exhibit low minimum seal temperature thresholds while at the same time exhibiting beneficial hot tack performance characteristics. The coating also provides positive blocking resistance, particularly to acrylic inks.

### DETAILED DESCRIPTION OF THE DISCLOSURE

This disclosure relates to heat sealable polymeric films. The heat sealable characteristics are provided by a coating applied to the polymeric substrate of the films. Low minimum seal temperatures and a reduction in the tendency to block against other coatings and inks are provided by the coatings. The coating may be applied to polymeric substrates having other coatings or overlayers such as a metallized layer. The minimum seal temperature of the coating is lower than the softening point of the film substrate thereby minimizing damage to the substrate during the heat sealing process. Minimum sealing temperature (“MST”) is the temperature necessary to achieve a 250 g/25 mm seal strength and with closed corners of a package on a packaging machine at a given speed.

The films of this disclosure are useful in packaging applications in which a package made from a polymeric film is filled with a product and then heat sealed. In such applications, generally speaking, the faster a package is routed through the filling and sealing process, the more economic the packaging process. Therefore, it is advantageous for the packing film to have a low minimum seal temperature to reduce the process residence time necessary to reach the minimum seal temperature. Of course, it is understood that the minimum seal temperature must not be too low so as to avoid activation of the sealing properties during storage or transit at high atmospheric temperatures. Moreover, the higher the seal strength of the heat seal immediately following the sealing operation, the faster the package may be processed thereafter without risking an unacceptably high seal failure rate. This characteristic, known as “hot tack”, is a measure of the cohesive strength of the heat seal during the cooling stage before solidification of a heat seal. Hot tack is determined by tearing a seal apart to measure the seal strength immediately after the seal is formed and before it cools down. Hot tack is measured in force per unit of seal width. Generally, the higher the hot tack the better since this will promote faster processing and handling of the sealed package.

The films described herein exhibit low minimum sealing temperatures while maintaining other beneficial characteristics such as good seal strength and hot tack properties.

The film coatings of this disclosure incorporate at least one ethylene copolymer component selected from the group of ethylene-acid copolymers and ethylene/acrylate copolymers. Exemplary ethylene copolymers are a copolymer of ethylene and acrylic acid (“EAA”) and a copolymer of ethylene and methacrylate (“EMA”). For purposes of this disclosure, the term copolymer refers to a polymer incorporating two or more monomers, including ethylene and/or acrylates as described above. For example, the term ethylene copolymers including ethylene-acid and ethylene acrylate copolymers incorporating additional monomers, including minor amounts of additional monomers.

The film coatings also incorporate at least one acid modified tackifier resin component. For purposes of this disclosure the term “acid modified” means incorporation of at least one carboxylic acid or the corresponding anhydride of the carboxylic acid. Films with coatings incorporating these components exhibit good blocking resistance against inks and coatings, low seal temperature thresholds, and high hot tack while at the same time preserving other beneficial blocking characteristics of EAA based coatings.

The polymeric substrates to which the coatings are applied may be any single or multi-layer polymeric material that can be formed into a film. The substrate can be clear or opaque. Additionally, the substrate may be colored or have a matte finish. The opacity of opaque films may be achieved by cavitating, creating voids, in one or more layers of the polymeric film substrate or by other means. For example, cavitation may be achieved through the use of organic or inorganic voiding agents or though production techniques independent of the use of voiding agents. Exemplary thermoplastic materials include any polyolefin, such as, polypropylene, polyethylene, polybutene, polystyrene, polyvinyl chloride, ethylene containing copolymers such as ethylene-propylene copolymers, ethylene containing terpolymers such as ethylene-butylene-propylene terpolymers, and blends thereof. Other suitable film materials include polyethylene terephthalate, other polyesters (including but not limited to polyethylene terephtalate glycol [PETG], polyethylene naphthalate [PEN] and liquid crystalline polymers [LCP]), and nylon, including oriented nylon.

In multilayer films, one or more skin layers are located on at least one surface of a thermoplastic core layer. Exemplary skin layers comprise polyethylene, including medium and high-density polyethylene, polypropylene, copolymers of propylene and ethylene and terpolymers of propylene, ethylene and butylenes, and blends thereof.

The various layers may contain processing aids or inorganic particulates, such as, titanium dioxide or void initiating agents to enhance the whiteness or color of the substrate or to enhance anti-blocking properties. Exemplary void initiators and techniques are disclosed in U.S. Pat. Nos. 5,885,721 and 6,168,826. Exemplary additional additives are slip, anti-block, and anti-static agents that are well known in the art and used to improve substrate functionality and properties. Additionally, as mentioned previously, the substrate may be metallized.

The substrate may be a single or multiple layers. For example, the substrate may be a 3-layer polymeric film which comprises a core layer and two outer layers, with the core layer comprising polypropylene. In another embodiment, the substrate may be a 5-layer polymeric film which comprises a core layer, two intermediate layers adjacent to the central core layer, and two outer layers, the polymer of at least one of the intermediate layers can comprise polypropylene.

A particular type of thermoplastic film which can be advantageously used in the substrate is molecularly oriented isotactic polypropylene. After extrusion of the substrate, for example, the base polypropylene film, utilizing conventional extrusion techniques, the film is heated and molecularly oriented by stretching it in both the longitudinal and transverse directions. The resulting oriented film exhibits greatly improved tensile and stiffness properties. Typically polyolefin resins, such as polypropylene, is extruded through a flat sheet extruder die at a temperature ranging from between about 200° C. to about 250° C., casting the film onto a cooling drum and quenching the film. The sheet is then stretched about 3 times to about 7 times in the machine direction (MD) orienter followed by stretching about 5 times to about 10 times in the transverse direction (TD) orienter.

The substrates in accordance with this disclosure may be oriented or hot-blown films made from any of a number of processes. The oriented films may be manufactured in a variety of processes including biaxial orientation, machine direction orientation (MDO), double bubble, simultaneous longitudinal and transverse orientation (LISIM®), tape bubble, trapped bubble or tenter framing. The use of linear motors to directly propel tenter clips to effect simultaneous longitudinal and transverse orientation is disclosed in U.S. Pat. No. 4,853,602. Hot-blown films are typically manufactured in a simple bubble process.

As mentioned above, the coatings in accordance with this disclosure incorporate at least one ethylene copolymer component and at least one acid modified tackifier resin component. The coatings may comprise from about 60 phr to about 99 phr ethylene copolymer and from about 1 phr to about 40 phr acid modified tackifier resin in one embodiment. In another embodiment, the coatings comprise from about 70 phr to about 98 phr ethylene copolymer and from about 2 phr to about 30 phr acid modified tackifier resin. In still another embodiment, the coatings comprise from about 90 phr to about 97 phr ethylene copolymer and from about 3 phr to about 10 phr acid modified tackifier resin. In this disclosure, “phr” means part per hundred based upon dry weight. In the formulation, the sum of the parts of ethylene copolymer and acid modified tackifier resin always equal 100. Other component levels in phr in the formulation are expressed versus the dry weight sum of EAA and acid modified tackifier resin that represents 100.

The ethylene copolymers useful in the coating compositions described herein may incorporate from about 65 wt. % to about 95 wt. % ethylene and from about 5 wt. % to about 35 wt. % acrylic acid or acrylate in one embodiment. In another embodiment, the ethylene copolymers may include from about 75 wt. % to about 85 wt. % of ethylene and from about 15 wt. % to about 35 wt. % acrylic acid or acrylate. In a third embodiment, the EAA copolymers may contain from about 80 wt. % to about 90 wt. % ethylene and from about 10 wt. % to about 20 wt. % acrylic acid or acrylate. The ethylene copolymers may have a number average molecular weight (Mn) of about 2,000 to 70,000 in one embodiment and from about 2,000 to about 40,000 in another embodiment. In still another embodiment, the average molecular weight (Mn) is from about 4,000 to about 10,000.

The ethylene copolymer components of the coatings described herein may be used in a variety of forms, including as a solution or fine dispersion of an ammonium salt of the copolymer in an ammoniacal water solution. When the copolymer is dried, ammonia is given off and the ionized and water sensitive carboxylate groups are converted to largely unionized and less water sensitive free carboxyl groups. In one embodiment for preparing coatings in accordance with this disclosure, there is added to the solution or dispersion of the ethylene copolymer an amount of ions of at least one metal from Group Ia, Ia or IIb of the Periodic Table, preferably, sodium, potassium, lithium, calcium or zinc ions, and most preferably sodium ions, e.g., in the form of their hydroxides. The quantity of such metallic ions may be in the range sufficient to neutralize, for example, about 2 to 80%, preferably about 10 to 50% of the total carboxylate groups in the copolymer. The presence of such metallic ions has been found to result in an improvement in certain properties, e.g., coefficient of friction (COF), hot tack, and blocking, without an unacceptable sacrifice of other properties, such as low minimum seal temperatures.

When the ethylene copolymer is a copolymer of 80 wt. % of ethylene and 20 wt. % of acrylic acid and the neutralizing metal ions are sodium ions added as sodium hydroxide, then the amount of sodium hydroxide added corresponding to the foregoing percentages of carboxylate groups neutralized, is, for example, about 0.33 phr (“parts by weight per hundred parts of the total resin”) to about 8.8 phr in one embodiment. In another embodiment, from about 1.1 to about 5.5 phr of the carboxylate groups are neutralized. For purposes of determining the phr's of the various additives present in the coating, the carboxylate groups of the ethylene copolymer are calculated in their free carboxyl (—COOH) or neutralized form.

The acid modified tackifier resins useful in the coatings of this disclosure may be prepared by a variety of known methods. Exemplary acid modifications of tackifier resin materials are disclosed in U.S. Pat. No. 4,242,244. Specifically, this patent discloses carboxyl group modifications of various resins.

Another exemplary acid modification of a tackifier resin useful in accordance with this disclosure is maleic anhydride grafting. Maleic anhydride-grafting of tackifier resins occurs when a polymer backbone is activated and reacts with maleic anhydride to form the graft. Levels of grafting can be adjusted by varying the amount of maleic anhydride introduced to the tackifier resin. The maleic anhydride-grafting can be carried out in a separate process, or in a continuous blending process.

Although no initiators are used in the processes outlined in U.S. Pat. No. 4,242,244 mentioned above, acid modification is often accomplished in the presence of an initiator, such as an organic peroxide. For instance, in the exemplary modification involving maleic anhydride grafting onto a tackifier resin, a graft initiator may be included with the maleic anhydride to perform a hydrogen abstraction from the tackifier resin backbone which initiates grafting of the maleic anhydride to the polymer chain. Alternatively, maleic anhydride can be grafted to a polymer through gamma or ultraviolet irradiation in the presence of a photosensitizer. Grafting yields a polymer containing covalently bonded individual succinic anhydride units formed by the reaction of maleic anhydride with the polymer. Further side reactions can provide cross-linking. Maleic anhydride grafting is described, for example, in Gaylord, “Reactive Extrusion in the Preparation of Carboxyl-Containing Polymers and Their Utilization as Compatibilizing Agents” in Reactive Extrusion: Principles and Practice, M. Xanthos, Ed., Carl Hanser Verlag, 1992, Ch. 3, pg. 58, and in U.S. Pat. No. 4,927,888, each of which is incorporated herein by reference.

Maleic anhydride grafted tackifier resins may be prepared by reactive compounding of the selected tackifier resin, maleic anhydride, and a grafting initiator. In general, maleic anhydride is blended with a grafting initiator which can be a peroxide, such as, dicumyl peroxide. Other suitable peroxides can be selected based on peroxide characteristics, such as the decomposition half life at processing temperature and the residence time in the specific reaction process equipment.

The polymer, maleic anhydride and grafting initiator can be added to the feed section of an extruder, melted, mixed and pressurized. Maleic anhydride is a solid at room temperature, and melts to a low viscosity liquid at approximately 550° C. Melted maleic anhydride can be pumped to the reactor or the solid can be pre-blended with the polymer prior to introduction to the reactor. The reactor can be a screw extruder (e.g., a single screw or twin screw extruder). After grafting is complete, maleic anhydride which is unreacted is removed from the blend. This can be conveniently accomplished by venting the extruder to atmosphere, or, preferably, by using a vacuum, after the reaction has been completed, and prior to passing through the die.

The grafted mixture is then forced through a die forming a strand that can be cooled and chopped into pellets for the next step in the process. Alternatively, a die that immediately chops the strands into pellets upon exiting the die can be used.

Tackifier resins suitable for acid modification and useful for the coating compositions of this disclosure include hydrocarbon resins, synthetic polyterpenes, resin esters and natural terpenes which are semi-solid or solid at ambient temperatures, and soften or become liquid at temperatures ranging generally from about 40° C. to about 150° C. in one embodiment. In another embodiment, the tackifier resins soften or become liquid at a temperature from about 70° C. to about 120° C. Exemplary tackifier resins are compatible resins such as (1) natural and modified rosins, for example, as gum rosin, wood rosin, tall oil rosin, distilled rosin, hydrogenated rosin, dimerized rosin, and polymerized rosin; (2) esters, including glycerol and pentaerythritol esters of natural and modified rosins, for example, as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; (3) copolymers and terpolymers of natured terpenes, e.g., pinene, limonene, styrene/terpene and alpha methyl styrene/terpene; (4) polyterpene resins having a softening point, as determined by ASTM method E28-58T, of from about 80° to 150° C.; the latter polyterpene resins generally resulting from the polymerization of terpene hydrocarbons, such as the bicylic monoterpene known as pinene, in the presence of Friedel-Crafts catalysts at moderately low temperatures; also included are the hydrogenated polyterpene resins; (5) phenolic modified terpene resins and hydrogenated derivatives thereof, for example, as the resin product resulting from the condensation, in an acidic medium, of a bicyclic terpene and a phenol; (6) aliphatic petroleum hydrocarbon resins having a Ball and Ring softening point of from about 40° C. to 140° C.; the latter resins resulting from the polymerization of monomers consisting primarily of olefins and diolefins; also included are the hydrogenated aliphatic petroleum hydrocarbon resins; (7) aromatic petroleum hydrocarbon resins, and mixed aromatic and aliphatic paraffin hydrocarbon resins, and the hydrogenated derivatives thereof; (8) aromatic modified alicyclic petroleum hydrocarbon resins and the hydrogenated derivatives thereof; and (9) alicyclic petroleum hydrocarbon resins, such as cyclopentadiene resins and the hydrogenated derivatives thereof.

In one embodiment, suitable aromatic tackifier resins are of molecular weight from about 300 to about 6,000. In another embodiment, the molecular weights range from about 750 to 1,000. In one embodiment, the aromatic tackifier resins have a softening point of less than 50° C. and are viscous liquids at room temperature. Suitable commercially available aromatic tackifier resins include “Piccolastic” A, D and E series. One such resin is Piccolastic A-25 which is a polystyrene resin having a softening point of 25° C., a color of 3 (Gardner), an acid number <1 and a specific gravity of 1.05 and a melt viscosity of 100 poise at 47° C. An exemplary group of tackifier resins include those available under the Escorez designations from ExxonMobil Chemical Company.

It has been determined, that generally the higher the degree of incorporation of acid functionality into the tackifier resin, the better the compatibility of the resin with the ethylene copolymer component which, in turn, will yield a more stable emulsion, a clearer coating, and improved seal performance of the coating. In one embodiment of this disclosure, the degree of acid functionality incorporation into the tackifier resin is from about 0.1% to about 50% in weight ratio of graft monomer to resin. In a second embodiment, the degree of maleic anhydride incorporation into the tackifier resin is from about 2.5% to about 20.0%. In still another embodiment, the degree of maleic anhydride incorporation into the tackifier resin is from about 10.0% to about 20.0%.

The low temperature sealable coating compositions described herein may also contain particulate materials such as amorphous silica to reduce the tack of the coating at room temperature. Amorphous silica is composed of particles which are agglomerations of smaller particles and which have an average particle size of about 2 to about 9 microns in one embodiment. In another embodiment, the particle size is about 3 to about 5 microns. The silica may be present in the sealable coating in a concentration of about 0.1 to about 2.0 phr in one embodiment. In another embodiment, the concentration is about 0.2 to about 0.4 phr. Other types of particulate materials can be used instead of amorphous silica. Suitable materials include polymethylmetacrylate spherical particles with an average particle size of from about 2 μm to about 6 μm in one embodiment. Such particulates are available under the designations EPOSTAR MA 1002 AND EPOSTAR MA 1004 manufactured by Nippon Shokubai Co., LTD and CALIBRE CA 6-6 manufactured by Polymer System. Also, silicone spherical particles with an average particle size of from about 2 μm to about 6 μm in one embodiment are suitable. Exemplary silicone particles are available under the designation TOSPEARL manufactured by Toshiba Silicone Co., LTD.

Other optional additives which may be included in the sealable coating of the films include other particulate materials such as talc which may be present in an amount, for example, of about 0.1 to 2 phr, anti-block and slip additives such as carnauba, montan, candellila, paraffin, synthetic, microcristalline, bee waxes and mixtures thereof can be included as well in a amount, for example, of about 2 to 12 phr. Cross-linking agents such as melamine formaldehyde resins which may be present in an amount, for example, of about 0.1 to 20 phr, and anti-static agents such as poly(oxyethylene) sorbitan monooleate which may be present in an amount, for example, of about 0.1 phr to 6 phr. An anti-bacterial agent may also be present. Sodium hydroxide may be included as well.

The low temperature sealable coating composition may be applied in any suitable manner such as by gravure coating, roll coating, dipping, spraying, etc. Squeeze rolls, doctor knives, etc., are useful to remove the excess coating solution. The coating compositions will ordinarily be applied in such an amount that there will be deposited following drying, a smooth, evenly distributed layer of from about 0.3 g/m² to about 1.8 g/m² of film surface in one embodiment. In another embodiment, the coating is applied at a thickness of about 0.5 g/m² to about 1.2 g/m². In still another embodiment, the thickness is from about 0.6 g/m² to about 1.0 g/m². In general, the thickness of the applied coating is such that it is sufficient to impart the desired sealability, coefficient of friction (COF), and hot slip characteristics to the substrate polymer film.

The coating, once applied to the film may be dried by hot air, radiant heat or by any other suitable means thereby providing a non-water soluble, adherent, glossy coated film product useful, for example, as a packaging film.

In one embodiment, the films described herein exhibit a minimum seal temperature of about 130° C. to about 160° C. on a packaging machine operating at 70 m/minute. In a second embodiment, the films described herein exhibit a minimum seal temperature of about 145° C. to about 155° C. on a packaging machine operating at 70 m/minute. In one embodiment, these minimum seal temperatures are achieved on a HFFS packaging machine. In still another embodiment, these minimum seal temperatures are achieved on a VFFS packaging machine.

In one embodiment, the coating of the films described in this disclosure exhibit a seal strength when sealed to itself on a static sealer, at a temperature of 75° C. and a pressure of 20 psi (1.4 kgf/cm²) for 1 second, from about 300 g/25 mm to about 600 g/25 mm. In another embodiment, the films described in this disclosure exhibit a seal strength from about 350 g/25 mm to about 500 g/25 mm at a temperature of 75° C. and a pressure of 20 psi (1.4 kgf/cm²) for 1 second. In a third embodiment, the films described in this disclosure exhibit a seal strength from about 400 g/25 mm to about 500 g/25 mm at a temperature of 75° C. and a pressure of 20 psi (1.4 kgf/cm²) for 1 second.

The following examples are illustrative of specific embodiments of the heat-sealable films of the present disclosure. All parts and percentages are by weight unless otherwise noted.

Experimental Evaluations

Pilot coater trials were performed on a three-layer clear polypropylene core film with a thickness of 29 μm and a density of 0.91 g/cm³. The skin layers were made of an ethylene-propylene-butylene terpolymer. The terpolymer had a composition of 2 wt. % to 4 wt. % ethylene and 3 wt. % to 15 wt. % butylene. One outer skin was first corona treated, precoated with PEI and then coated with 0.8 g/m² dry of a Comparative coating containing 100 phr of EAA (20 wt. % acrylic acid), 1.5 phr of NaOH, 4 phr of carnauba wax, 0.2 phr of syloid 4μ and 0.4 phr of talc. A PEI coating is a continuous coating of a primer material. Such primer materials are well known in the art and include, for example, epoxy and poly(ethylene imine) (PEI) materials as disclosed in U.S. Pat. Nos. 3,753,769; 4,058,645; 4,439,493; and 6,623,866. The characteristics of this film were compared to a 29 μm three-layer clear polypropylene core layer films of the same composition as coated with the Comparative formulation. After corona treatment and priming with PEI, the film was coated with thirteen formulations (1-13) of a blend of an EAA copolymer (20 wt. % acrylic acid) and maleic anhydride grafted tackifier resin (EMFR 100 available from ExxonMobil Chemical Company) as set forth in Table I along with the Comparative coating composition. EMFR 100 is a maleated thermally polymerized, hydrogenated, aromatic-dicyclopentadiene-based hydrocarbon resin containing 2.5 wt. % maleic anhydride. Additional information regarding these types of resins is found in WO 03/025084; WO 03/025036; WO 03/025037; and WO 03/025038.

TABLE I

| | EAA | EMFR 100 | NaOH | Wax | Syloid | Talc |
|---|---|---|---|---|---|---|
| Comparative | 100 | 0 | 1.5 | 4 | 0.2 | 0.4 |
| Formulation 1 | 90 | 10 | 1.5 | 4 | 0.2 | 0.4 |
| Formulation 2 | 80 | 20 | 1.5 | 4 | 0.2 | 0.4 |
| Formulation 3 | 70 | 30 | 1.5 | 4 | 0.2 | 0.4 |
| Formulation 4 | 95 | 5 | 0.71 | 4 | 0.2 | 0.4 |
| Formulation 5 | 90 | 10 | 0.67 | 4 | 0.2 | 0.4 |
| Formulation 6 | 80 | 20 | 0.6 | 4 | 0.2 | 0.4 |
| Formulation 7 | 70 | 30 | 0.5 | 7 | 0.2 | 0.4 |
| Formulation 8 | 95 | 5 | 0 | 4 | 0.2 | 0.4 |
| Formulation 9 | 95 | 5 | 1.42 | 4 | 0.2 | 0.4 |
| Formulation 10 | 95 | 5 | 1.9 | 4 | 0.2 | 0.4 |
| Formulation 11 | 97 | 3 | 1.5 | 4 | 0.2 | 0.4 |
| Formulation 12 | 97 | 3 | 2.0 | 4 | 0.2 | 0.4 |
| Formulation 13 | 97 | 3 | 2.5 | 4 | 0.2 | 0.4 |

Crimp seal strength was measured on the reference formulation and formulations 1-3 of Table I and the measured seal strength values are reported in Table II.

TABLE II

| | 70° C. | 75° C. | 80° C. |
|---|---|---|---|
| Comparative | 0 | 0 | 500 |
| Formulation 1 | 280 | 500 | not measured |
| Formulation 2 | 300 | 570 | not measured |
| Formulation 3 | 350 | 400 | not measured |

The seal conditions are: Pressure 20 psi, Time 1 sec., Temperature: 70° C., 75° C. and 80° C.
The seal strengths are expressed in g/25 mm

Films incorporating the coating formulations of the Comparative coating and coatings of Formulations 4-13 were run on a HFFS packaging machine at a machine speed of 70 m/min to form packages by sealing the coating layer to itself. The minimum seal temperatures (“MST”) of the coated films were determined as reported in Table III.

TABLE III

| | MST in ° C. | Delta from Comparative in ° C. |
|---|---|---|
| Comparative | 158 | N/A |
| Formulation 4 | 148 | −10 |
| Formulation 5 | 150 | −8 |
| Formulation 6 | 160 | +2 |
| Formulation 7 | 165 | +7 |
| Formulation 8 | 144 | −14 |
| Formulation 9 | 146 | −12 |
| Formulation 10 | 150 | −8 |
| Formulation 11 | 152 | −6 |
| Formulation 12 | 156 | −2 |
| Formulation 13 | 166 | +8 |

As seen by comparing these Examples, coatings incorporating an acid modified tackifier resin at a range below 20 phr demonstrated a lowering of the minimum seal temperature when run on a HFFS packaging machine as compared to standard EAA coated films without an acid modified tackifier resin.

Additionally, coatings incorporating an acid modified tackifier resin at a range up to 20 phr demonstrated better seal strength properties as compared to coatings not incorporating the acid modified tackifier component.

All patents and publications referred to herein are hereby incorporated by reference in their entireties.

Although the present invention and its advantages have been described in detail, it should be understood that various changes, substitutions, and alterations could be made without departing from the spirit and scope of the invention as defined by the following claims.

What is claimed is:

1. A polymeric film comprising:
(a) a film substrate comprised of at least one polymeric layer having a first surface and a second surface; and
(b) a coating on at least one of the first and second surfaces and wherein the coating is comprised of (i) an ethylene copolymer component selected from the group consisting of ethylene-acrylic acid copolymers and an ethylene-acrylate copolymers and (ii) a tackifier resin component.

2. The polymeric film of claim 1 wherein the coating is comprised of about 60 phr to about 99 phr of the ethylene copolymer component and from about 1 phr to about 40 phr of the tackifier resin.

3. The polymeric film of claim 2 wherein the tackifier resin component is an acid modified tackifier resin.

4. The polymeric film claim 3 wherein the ethylene copolymer component is a copolymer comprising ethylene and acrylic acid.

5. The polymeric film of claim 4 wherein the coating has a seal strength of about 350 g/25 mm to about 500 g/25 mm at a temperature of 75° C. and 20 psi for 1 second.

6. The polymeric film of claim 4 wherein the coating has a minimum seal temperature from about 130° C. to about 160° C. at 70 m/minute.

7. The polymeric film of claim 6 wherein the acid modified tackifier resin has a degree of acid functionality incorporated into the tackifier resin of from about 0.1% to about 50%.

8. The film of claim 7 wherein the substrate is comprised of a material selected from the group consisting of polypropylene, polyethylene, polybutene, polystyrene, polyvinyl chloride, polyesters, polyethylene terephtalate glycol, polyethylene naphthalate, and oriented nylon.

9. The film of claim 8 wherein the acid modified tackifier resin is a maleic anhydride grafted tackifier resin.

10. The film of claim 9 wherein the tackifier resin is selected from the group consisting of hydrogenated aliphatic petroleum hydrocarbon resins; aromatic petroleum hydrocarbon resins, mixed aromatic and aliphatic paraffin hydrocarbon resins, aromatic modified alicyclic petroleum hydrocarbon resins; and alicyclic petroleum hydrocarbon resins.

11. The film of claim 10 wherein the acid modified tackifier resin has a degree of acid functionality incorporated into the tackifier resin of from about 1.0% to about 50%.

12. The film of claim 11 wherein the substrate is comprised of a material selected from the group consisting of oriented polyolefin film, biaxially oriented polyolefin film, and biaxially oriented polypropylene film.

13. The film of claim 12 wherein the coating has a minimum seal temperature from about 145° C. to about 155° C. at 70 m/minute and a seal strength of about 400 g/25 mm to about 500 g/25 mm at a temperature of 75° C. and pressure of 20 psi for 1 second.

14. The film of claim 13 wherein the substrate of the film is comprised of at least three layers.

15. The film of claim 14 wherein the film is opaque.

16. The film of claim 15 wherein at least one layer of the film is voided.

17. A package comprised of:
(a) a film substrate comprised of at least one polymeric layer having a first surface and a second surface; and
(b) a coating on at least one of the first and second surfaces and wherein the coating is comprised of (i) an ethylene copolymer component selected from the group consisting of ethylene-acrylic acid copolymers and ethylene-acrylate copolymers and (ii) a tackifier resin component.

18. The package of claim 17 wherein the coating is comprised of about 60 phr to about 99 phr of the ethylene copolymer component and from about 1 phr to about 40 phr of the tackifier resin and wherein the tackifier resin component is an acid modified tackifier resin.

19. The polymeric film claim 18 wherein the ethylene copolymer component is a copolymer comprising ethylene and acrylic acid and the acid modified tackifier resin is a maleic anhydride grafted tackifier resin.

20. The polymeric film of claim 19 wherein the coating has a seal strength of about 350 g/25 mm to about 500 g/25 mm at a temperature of 75° C. and 20 psi for 1 second and the coating has a minimum seal temperature from about 130° C. to about 160° C. at 70 m/minute.
